(19) United States
(12) Patent Application Publication
(10) Pub. No.: US 2008/0295795 A1
(43) Pub. Date: Dec. 4, 2008

(54) Laminated Internal Combustion Engine and Fabrication Technique

(76) Inventor: Ted Hollinger, Algona, IA (US)

Correspondence Address: DAVIS, BROWN, KOEHN, SHORS & ROBERTS, P.C.;THE DAVIS BROWN TOWER, 215 10TH STREET SUITE 1300, DES MOINES, IA, 50309, US

(21) Appl. No.: 12/129,177

(22) Filed: May 29, 2008

Related U.S. Application Data
(60) Provisional application No. 60/932,107, filed on May 29, 2007.

(51) Int. Cl. F02F 1/00; B23P 15/00

(52) U.S. Cl. 123/193.2; 123/195 R; 29/888.01

(57) ABSTRACT

The engine block for an internal combustion engine is fabricated from laminated pieces of material instead of cast iron or cast aluminum. This provides extreme flexibility of the design of individual engines. Each lamination piece can be designed to complex three dimensional structures and/or passages. The lamination material itself can be changed to improve strength, thermal conductivity, reduce cost, or any other parameter of interest to those skilled in the art.

This application claims priority to U.S. Patent Application Ser. No. 60/932,107 filed May 29, 2007.

### BACKGROUND OF THE INVENTION

The present invention relates generally to internal combustion engines and, more specifically, to internal combustion engines that are fabricated from laminated pieces of material rather than cast iron or aluminum. The present invention also relates to internal combustion engine manufacturing. The engine manufacturing technique is useful for any internal combustion engine including diesel engines.

Internal combustion engine blocks have been manufactured using cast iron and/or aluminum for many years. The shape of the engine block has been achieved through the use of complex multi piece molds. Once the block has been poured it is very difficult to ensure that the casing thickness is uniform and that it is not porous. The composition of the ‘poured’ material can vary slightly form pour to pour and can be adjusted by those with expertise in the techniques. However, within a single block the material, whatever its composition is, will be uniform.

There is a need for engines of very specific designs that do not initially have high production potential. This is especially true of engines fueled by fuels like hydrogen. The high cost and long development time of conventional engine molds makes it prohibitively expensive to develop these needed specialty engines. A new method of design and fabrication is needed. The preferred solution does not involve complex engine molds.

### SUMMARY OF THE INVENTION

The present invention consists of engine blocks for internal combustion engines that are fabricated from layers or laminations of material. The laminations may be comprised of any suitable material that will withstand the environment of an internal combustion engine, such as steel, iron, aluminum and other metals, or even high strength, high temperature composites and plastics, including transparent materials to allow visual inspection of the interior or the engine block. The composition, number and thickness of the individual laminations may vary from engine and within engines, depending on the application. For example, an engine of the present invention may be easily modified by the removal or addition of laminations, thereby reducing or increasing the volume of the engine, respectively. Such engines are particularly suited to research applications where modifications in design can be implemented easily, inexpensively, and quickly.

### BRIEF DESCRIPTION OF THE DRAWING

FIG. 1 is an exploded perspective view of an engine block of the present invention.

### DETAILED DESCRIPTION OF PREFERRED EMBODIMENTS

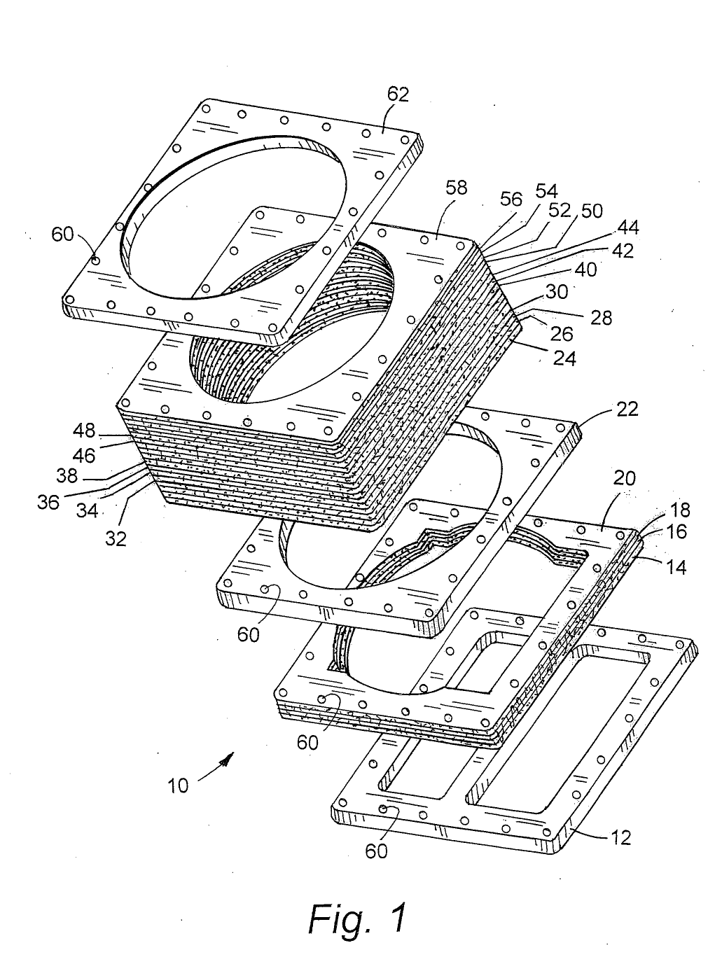

Referring to FIG. 1, a preferred embodiment of the present invention is illustrated generally at 10. The new engine design is started by designing a cage to hold the crankshaft and the main bearings. Preferably this cage uses standard bearings and oiling techniques, but is not limited to them. This crankcase cage has a cylinder base plate 12 that is attached to it or designed into it. This cylinder base plate 12 strengthens the crankcase cage and acts as a base for studs or bolts that will be used to clamp the laminated layers together.

Individual layers or laminations are designed to form the cylinders and associated openings generally found in molded engines. Illustrated in FIG. 1 are laminations 14-20, lamination 22, and laminations 24-46, arranged in a stacked relation. Each lamination 14-58 is perforated by a plurality of bolt-receiving openings 60. The outside of the laminations 14-58 forms the exterior of the engine block 10 with all the associated connection and attachment points. Each lamination 14-58 can be custom designed, fabricated, and fully inspected prior to assembly. Individual laminations may be formed with voids to create passages through which a variety of materials may pass through the block. For example, a void may comprise a channel for cooling fluid to pass through the engine block 10. Alternatively, a void may form a passage for a test probe wherein the probe may be located near the cylinder with the wires passing through the passage to the exterior of the block 10.

The laminations 14-58 are assembled, one on top of another, with the plurality of bolts passing through corresponding ones of the openings 60 until the stack portion of the block 10 is completed. A top cylinder plate 62 is then added to secure the bolts or studs and allow them to be tightened until the compressed stack plus the upper and lower cylinder plates 12 and 62, respectively, form the equivalent of a monolithic structure. The cylinder sleeves (not shown), either wet or dry, are then installed and the engine block is complete. All other engine parts can be made and installed by conventional techniques. Each lamination can be made from flat material and custom cut to form a “slice” of a conventional engine or be formed to achieve designs not possible with molded blocks.

In a preferred embodiment, a 1.6 L (100 in³) two (2) cylinder HEC Oxx Power block was converted to a 3.9 L (240 in³) single cylinder block by cutting off the top 1.6 L engine block in such a way that the bottom portion forms the crankcase cage. The crankcase cage was then machined for proper sizing. The lower cylinder plate 12 was then added, followed by a selected number of laminations and then the upper cylinder plate 50 until the final result was a large bore, single cylinder block. A two-tip crankshaft was then added along with a dual connecting rod piston. This combination formed the short block portion of the engine and demonstrated that the technique works correctly.

It may be desired to use laminations comprised of materials which have a grain structure that have been formed or worked such as plate exhibit greater strength in one boundary or plane than the other, such as some cast irons. The strength of the lamination stack can be improved by arranging lamination plates whereby their granular arrangement is pivoted at an angle relative to each other, preferably pivoted by 90 degrees for adjacent laminations, which assures that the strength of the lamination stack is uniform in the horizontal axis. Additionally, this technique can be carried into the vertical axis of the stack by processing a portion of the lamination so that the formed structure of the material is finished and arranged to promote greatest metallurgical strength in the vertical axis.

Also within the scope of the present invention is the use of laminations that are not comprised of only a single material. For example, portions of a lamination may be comprised of one material while other portions are comprised of one or more other materials. By way of a specific example, a lamination may have portions made of steel while other portions may be made of easier to machine aluminum. Sealing laminations may be desirably used in certain circumstances wherein the lamination is made of an elastomeric or malleable material that provides an improved seal between adjacent layers of the block. It may also be desirable to fabricate the laminations with a non-uniform thickness and possibly with shapes or contours that interlock with adjacent laminations similar to puzzle pieces. Alternatively, the laminations used in a single engine block may have differing thermal conductivities or individual laminations may be made of materials having diverse thermal conductivities. It is also contemplated that the laminations used in a single engine block may have differing magnetic properties or individual laminations may be made of materials having diverse magnetic properties.

The foregoing description and drawings comprise illustrative embodiments of the present inventions. The foregoing embodiments and the methods described herein may vary based on the ability, experience, and preference of those skilled in the art. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art that have the disclosure before them will be able to make modifications and variations therein without departing from the scope of the invention.

What is claimed is:

1. An internal combustion engine block, comprising a plurality of laminations.

2. An engine block as defined in claim 1, wherein at least one lamination is comprised of a material different from that of the other laminations.

3. An engine block as defined in claim 1, wherein at least one lamination has a thicknesses that is different from that of other laminations.

4. An engine block as defined in claim 1, wherein at least one lamination layer comprises voids.

5. An engine block as defined in claim 1, wherein at least one lamination layer is comprised of materials having a grain structure or grain orientation.

6. An engine block as defined in claim 1, wherein adjacent laminations comprised of materials having a grain structure or grain orientation are aligned with the grain structure or grain orientation pivoted relative to each other.

7. An engine block as defined in claim 1, wherein at least one of the laminations is comprised of a material for creating a seal between adjacent laminations.

8. An engine block as defined in claim 1, where at least one lamination has a non-uniform thicknesses.

9. An engine block as defined in claim 1, where a pair of adjacent lamination interlock with each other.

10. An engine block as defined in claim 1, wherein at least one lamination layer is comprised of transparent materials.

11. An engine block as defined in claim 1, wherein at least one lamination is comprised of a material having a different thermal conductivity than the other laminations.

12. An engine block as defined in claim 1, wherein at least one lamination is comprised of materials having diverse thermal conductivities.

13. An engine block as defined in claim 1, wherein at least one lamination is comprised of materials having diverse magnetic properties.

14. An engine block as defined in claim 1, wherein two or more laminations are welded together after assembly.

15. A method of fabricating an internal combustion engine, comprising the steps of assembling a stack of laminations.

16. A method as defined in claim 15, further comprising the step of vacuum impregnating the assembled laminations.

17. A method as defined in claim 15, further comprising the step of vacuum fusing together the assembled laminations.
